(19) United States
(12) Patent Application Publication
(10) Pub. No.: US 2026/0054342 A1
(43) Pub. Date: Feb. 26, 2026

(54) APPARATUS AND METHOD OF GENERATING TOOL MARK FOR 3D DIGITAL CONVERSION RESEARCH

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Je Hyun LEE, Wonju-si (KR); Jong Taek PARK, Wonju-si (KR); Chang Ho CHOI, Wonju-si (KR); Sae Han PARK, Wonju-si (KR); Dong Gyu LEE, Daejeon (KR); Jeong Heon PARK, Wonju-si (KR)

(21) Appl. No.: 19/276,787

(22) Filed: Jul. 22, 2025

(30) Foreign Application Priority Data
Aug. 20, 2024 (KR) 10-2024-0111351

(51) Int. Cl. B23Q 17/09

(52) U.S. Cl. CPC B23Q 17/099

(57) ABSTRACT

A tool mark generating apparatus for 3D digital conversion research according to an embodiment includes: a base plate; a vise portion located on the base plate to fix a target object at a position spaced from the base plate; and an operating portion configured to fix a tool on one side and apply an impact to the target object by moving the tool to form a pressed mark or perforation, wherein the operating portion includes: a step motor, a main screw, a nut, and a tool block that fixes at least one tool by inserting and securing the tool in a vertically aligned position.

### CROSS-REFERENCE TO RELATED APPLICATIONS

The present application is based on and claims priority to Korean Patent Application No. 10-2024-0111351, filed on Aug. 20, 2024, in the Korean Intellectual Property Office, which is incorporated herein by reference in its entirety.

### BACKGROUND

### 1. Field

One or more embodiments relate to an apparatus and a method of generating a tool mark for three-dimensional (3D) digital conversion research.

### 2. Description of the Related Art

In crime scenes involving incidents such as theft, murder, or arson, target objects may be damaged or deformed by tools or similar instruments. In such situations, analyzing the scene to identify the specific tool involved plays a critical role in criminal investigations aimed at determining the method used to commit the crime.

When the surface of a target object is pressed or pierced by a tool, the shape of the tool may be inferred based on the resulting tool marks. However, during the analysis of such tool marks, typically only the outline of the pressed or pierced portion is visible, which often makes it difficult to accurately determine the identity or features of the target object.

A tool that leaves a pressed mark or perforation is a three-dimensional object, and the corresponding mark or perforation formed on the target object also has a three-dimensional structure. Accordingly, securing or reconstructing the 3D geometry of the tool that pressed or pierced the surface is essential for accurately analyzing the corresponding marks or perforations found on physical evidence at the crime scene.

### SUMMARY

One or more embodiments include an apparatus and a method for forming a three-dimensional trace by precisely controlling a depth at which a tool is inserted into a target object by a step motor control method.

In addition, one or more embodiments include an apparatus and a method for forming various pressed marks and perforations using various tools and target objects for comparative study of traces.

According to one or more embodiments, a tool mark generating apparatus for 3D digital conversion research includes: a base plate; a vise portion located on the base plate to fix a target object at a position spaced from the base plate; and an operating portion configured to fix a tool on one side and apply an impact to the target object by moving the tool to form a pressed mark or perforation, wherein the operating portion comprises: a step motor that rotates at a certain angle in response to a user's input signal; a main screw having a cylindrical shape configured to convert rotational motion of the step motor into linear motion and to have an external screw thread; a nut configured to include an internal screw thread that engages with the screw thread of the main screw and perform linear motion along an axis of the main screw; and a tool block that is coupled to one side of the nut, moves according to movement of the nut, and fixes at least one tool by inserting and securing the tool in a vertically aligned position.

In an embodiment, the vise portion may include a vise body located on the base plate, a first jaw located on one side of the vise body to form a certain height, a second jaw located opposite one side of the first jaw, an adjustment screw having one end inserted and connected to at least one side of the first and second jaws to adjust a gap between the first and second jaws, and a handle screw connected to the other end of the adjustment screw to adjust a rotation direction of the adjustment screw.

In an embodiment, the tool mark generating apparatus may further include a frame portion configured to fix the step motor and the main screw such that an axial direction of the main screw is oriented vertically.

In an embodiment, the tool mark generating apparatus may further include a sensor unit disposed on upper and lower portions of the frame portion to detect upper and lower limits of a movement range of the tool.

In an embodiment, the tool mark generating apparatus may further include a target object fixing portion located on the first and second jaws and having a concave groove formed therein to accommodate the target object.

In an embodiment, the tool mark generating apparatus may further include a control unit configured to control an operation of the step motor based on user's input information.

In an embodiment, the user's input information may include a rotation speed or a rotation acceleration of the step motor.

A method of generating a tool mark for 3D digital conversion research according to an embodiment includes: inserting a tool into a tool mark generating apparatus for 3D digital conversion research and fixing a target object; bringing the tool into contact with the target object; and forming a tool mark by moving the tool downward to form a three-dimensional pressed mark or perforation on the target object.

In an embodiment, the forming of the tool mark may include controlling an insertion depth of the tool by adjusting a rotation speed or a rotation acceleration of a step motor.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of a tool mark generating apparatus according to an embodiment;

FIG. 2 is a side view of a tool mark generating apparatus according to an embodiment;

FIGS. 3A and 3B are views of sensor units of FIGS. 1 and 2;

FIGS. 4 and 5 are block diagrams of tool mark generating apparatuses according to embodiments; and

FIG. 6 is a flowchart illustrating a tool mark generating method according to an embodiment.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various elements, these elements should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

It will be understood that when a layer, area, or component is referred to as being “formed on” another layer, area, or component, it can be directly or indirectly formed on the other layer, area, or component. That is, for example, intervening layers, areas, or components may be present.

Sizes of components in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

It will be understood that when a layer, region, or component is connected to another portion, the layer, region, or component may be directly connected to the portion or an intervening layer, region, or component may exist, such that the layer, region, or component may be indirectly connected to the portion.

In the disclosure, ‘tool’ refers to a tool for performing work and tasks in industry and life in general. For example, tools that can be used in cases of theft or arson include hammers, crowbars, hatchets, flat-head screwdrivers, cross-head screwdrivers, awls, scissors, knives, etc.

In the disclosure, ‘target object’ refers to an object that is deformed by a tool and leaves a trace at a crime scene such as theft or arson. For example, the material of the target object may include a living body, metal, wood, etc., and the target object may include various shapes such as a butane gas cylinder, a plate, etc.

In the disclosure, ‘tool mark’ refers to a trace left when a tool comes into contact with a target object.

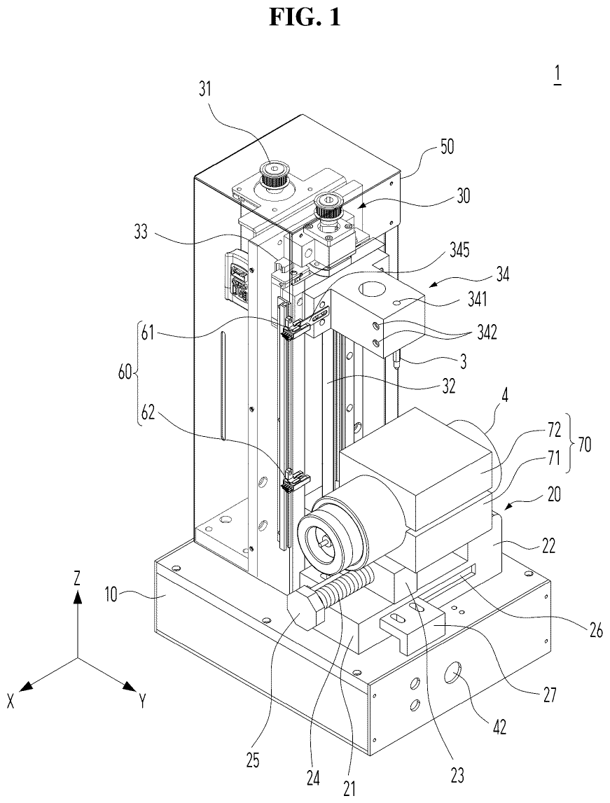

Hereinafter, a tool mark generating apparatus for 3D digital conversion research according to an embodiment will be described with reference to FIGS. 1 to 5.

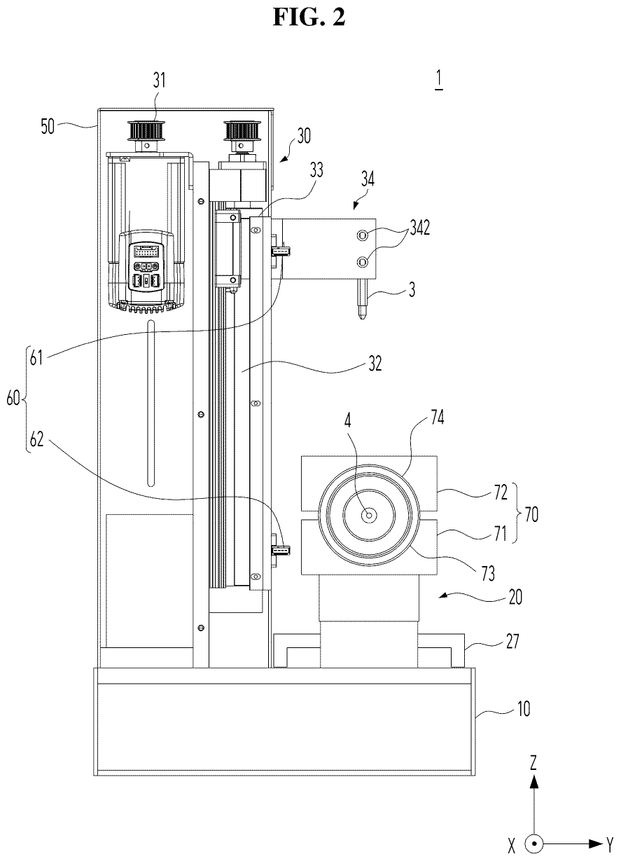

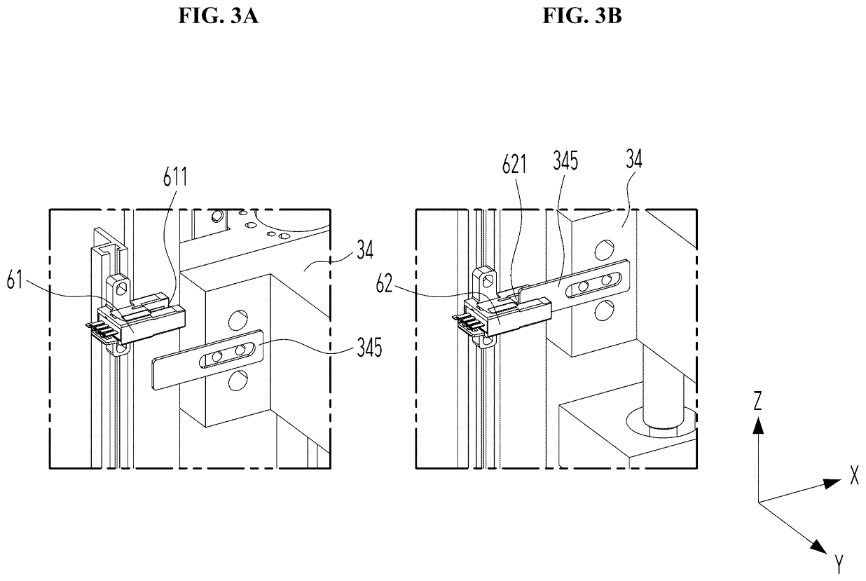

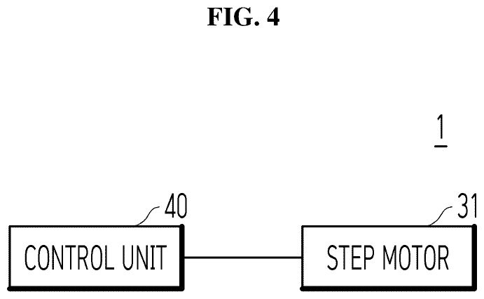

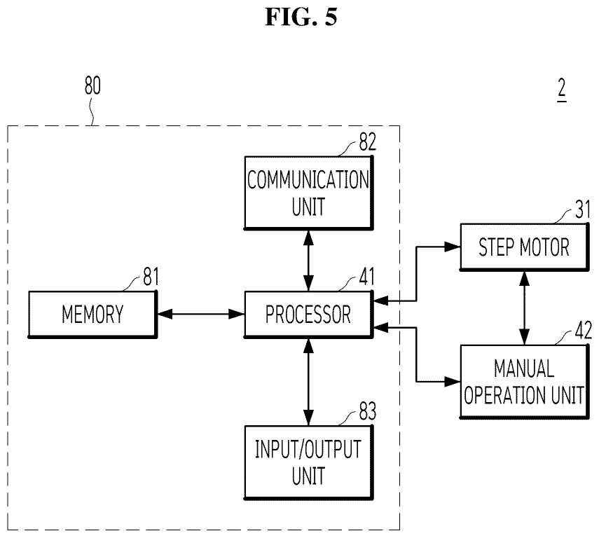

FIG. 1 is a perspective view of a tool mark generating apparatus according to an embodiment, and FIG. 2 is a side view of a tool mark generating apparatus according to an embodiment. FIGS. 3A and 3B are views of sensor units of FIGS. 1 and 2. FIGS. 4 and 5 are block diagrams of tool mark generating apparatuses according to embodiments.

Referring to FIGS. 1 to 5, a tool mark generating apparatus 1 according to an embodiment may include a base plate 10, a vise portion 20, a target object fixing portion 70, an operating portion 30, a frame portion 50, a sensor unit 60, and a control unit 40.

The base plate 10 may be located on a floor, a workbench, or the like to fix and stably support positions of components installed thereon.

The vise portion 20 may be located on the base plate 10 and may fix a target object 4 at a position spaced from the base plate 10. The vise portion 20 may include a vise body 21, a first jaw 22, a second jaw 23, an adjustment screw 24, and a handle screw 25.

The vise body 21 may be disposed on the base plate 10. For example, the vise body 21 may be formed in a hexahedral shape. A guide slot 26 may be formed in a lateral direction of the vise body 21. A fixing member 27 may be inserted into the guide slot 26 and fastened to the base plate 10 to fix the position of the vise body 21. For example, the fixing member 27 may have an L-shaped block structure, one side of which is inserted into the guide slot 26, and its position may be fixed using a fastening screw (not shown). However, the component for fixing the vise portion 20 to the base plate 10 is not limited to this specific configuration.

The first jaw 22 may be located on one side of the vise body 21 and may have a certain height.

The second jaw 23 may be positioned to face one side of the first jaw 22. At this time, the first jaw 22 and the second jaw 23 may each be formed in a hexahedral shape.

The adjustment screw 24 may be connected to at least one of the first jaw 22 and the second jaw 23 to adjust a gap between the two jaws by rotating the screw to move one of the jaws. For example, the first jaw 22 may be fixed, and one end of the adjustment screw 24 is inserted into one side of the second jaw 23 to move a position of the second jaw 23.

The handle screw 25 may be connected to the other end of the adjustment screw 24 to adjust the rotation direction of the adjustment screw 24.

In summary, one end of the adjustment screw 24 may be inserted into and connected to one side of either the first jaw 22 or the second jaw 23, and the other end of the adjustment screw 24 may be connected to the handle screw 25.

The target object 4 may be fixed by positioning it between the first jaw 22 and the second jaw 23 of the vise portion 20 and adjusting the gap therebetween. In addition, depending on the type of the target object 4, a jig (not shown) may be used to maintain the shape of the target object 4 and fix it without deformation.

The target object fixing portion 70 may be located on the first jaw 22 and the second jaw 23 of the vise portion 20, and may have concave grooves 73 and 74 formed to accommodate the target object 4.

The target object fixing portion 70 may include a body 71 that can be placed on the first jaw 22 and the second jaw 23 of the vise portion 20, the body 71 having the first concave groove 73 formed therein to accommodate the target object 4. In addition, the target object fixing portion 70 may further include a cover 72 having the second concave groove 74 formed therein, the cover 72 being configured to cover an upper portion of the target object 4 after the target object 4 is seated in the body 71. The target object 4 may be fixed using only the body 71, and the cover 72 may optionally be used to more securely fix the target object 4. The cover 72 may be removably disposed on the target object 4 and may be formed of a material through which a tool 3 can easily pass.

At this time, the concave grooves 73 and 74 may be formed to accommodate the outer surface of the target object 4. For example, the shape of the concave grooves 73 and 74 may be a sphere, a hexahedron, or other shape. In addition, as shown in the drawings, the concave grooves 73 and 74 may be shaped to accommodate a cylindrical object such as a butane gas cylinder. The shape of the concave grooves 73 and 74 may be varied depending on the shape of the target object 4.

Therefore, the target object 4 may be directly fixed between the first jaw 22 and the second jaw 23 of the vise portion 20, or may be fixed using the target object fixing portion 70.

Because the first jaw 22 and the second jaw 23 of the vise portion 20 are formed at a certain height from the base plate 10, the target object 4 may be directly fixed to the vise portion 20 while maintaining its three-dimensional shape. Even when the target object fixing portion 70 is used, the target object 4 may be positioned on the first jaw 22 and the second jaw 23 and fixed in a state where its three-dimensional shape is maintained.

Accordingly, traces may be formed and observed on both outer and inner surfaces of the three-dimensional target object 4 impacted by the tool 3. Such traces are not limited to being observed from only one side of the target object 4, but may instead be three-dimensional traces observable from multiple directions.

For example, if the target object 4 is a butane gas cylinder and the tool 3 is a screwdriver blade, a trace may be formed on an outer surface of the butane gas cylinder, and a trace may also be formed on an inner surface of the butane gas cylinder through which the screwdriver blade passed. Therefore, a three-dimensional trace may be formed on the target object 4, and the trace formed on the target object 4 may be observed and photographed from various directions.

The operating portion 30 may form a pressed mark or perforation by fixing the tool 3 on one side thereof and then moving the tool 3 to apply an impact to the target object 4.

For example, the operating portion 30 may include a step motor 31, a main screw 32, a nut 33, and a tool block 34.

The step motor 31 is a type of electric motor that performs stepwise rotation at a certain angle. The step motor 31 may rotate at a certain angle in response to a user's input signal.

The main screw 32 may be a cylindrical shaft having external screw threads, and may convert the rotational motion of step motor into linear motion. The main screw 32 may be connected to a shaft of the step motor 31. For example, the main screw 32 may be in the form of a lead screw or a ball screw.

The nut 33 may include an internal screw thread that engages with a screw thread of the main screw 32 and may perform linear movement along an axis of the main screw 32.

The tool block 34 may be coupled to one side of the nut 33 and may move according to the movement of the nut 33. The tool block 34 may be configured to fix at least one tool 3 inserted therethrough.

The tool block 34 may include an insertion hole 341 formed vertically therethrough, into which the tool 3 is inserted. While the tool 3 is inserted in the insertion hole 341, it may be fixed from the side using an adjustment screw 342. By inserting tools 3 of various sizes into the insertion hole 341 and securing them with the adjustment screw 342, traces of various tools 3 may be formed.

The frame portion 50 may fix the step motor 31 and the main screw 32 so that an axial direction of the main screw 32 is generally vertical. Accordingly, the nut 33 may move vertically along the axis of the main screw 32 by operation of the step motor 31. The tool block 34 is connected to the nut 33, and the tool 3 inserted into the tool block 34 may move vertically.

The sensor unit 60 may be disposed on the upper and lower sides of the frame portion 50 to detect the upper and lower limits of the movement range of the tool 3.

For example, referring to FIGS. 3A and 3B, the sensor unit 60 may include a first sensor 61 and a second sensor 62, which are attached to the upper and lower sides of the frame portion 50, respectively.

The first sensor 61 and the second sensor 62 may each have a penetrating groove 611 and 621 formed on one side thereof. A detection target 345, which is to be detected by the first sensor 61 and the second sensor 62, may be attached to one side of the tool block 34.

As the tool block 34 moves, the detection target 345 attached to one side thereof may move up and down and pass through the penetrating grooves 611 and 621 of the first and second sensors 61 and 62. Upon passing through the penetrating grooves, the position of the detection target 345 is detected and a signal is generated. The generated signal may be transmitted to the control unit 40, which may determine the upper or lower limit of the movement position of the tool block 34. Since the downward movement of the tool 3 is restricted at the point where the detection target 345 passes through the second sensor 62 located on the lower side, the risk caused when the tool 3 strikes the target object 4 may be reduced.

From the perspective of one of ordinary skill in the art, the sensor unit 60 includes various configurations for detecting the position of the tool 3, and is not limited to a specific configuration.

Referring to FIG. 4, the control unit 40 may control the operation of the step motor 31 based on user's input information.

The control unit 40 may include one or more of a digital signal processor (DSP), a microprocessor, a micro controller unit (MCU), a controller, and an application processor AP for processing a digital signal.

At this time, the user's input information may include a rotation speed or a rotation acceleration of the step motor 31. The rotation speed of the step motor 31 may be controlled by adjusting the period or frequency of an input pulse. Rotation acceleration control of the step motor 31 refers to a change of the rotation speed of the step motor 31, and may be controlled by gradually changing a period of a step pulse.

Furthermore, the control unit 40 may control a start or stop of the step motor 31 based on upper and lower limits of the position of the tool block 34 detected by the sensor unit 60.

In addition, the control unit 40 may further include a manual operation unit 42.

In an embodiment, the manual operation unit 42 may be located on one side of the base plate 10. A user may operate the manual operation unit 42 to control an operation direction of the tool 3. For example, the manual operation unit 42 may be operated using a jog wheel or a jog button. When a user operates the jog wheel in (−) direction, the tool 3 may be moved upward, and when a user operates the jog wheel in (+) direction, the tool 3 may be moved to a lower side.

Furthermore, a user may operate the step motor 31 via the manual operation unit 42, or use the manual operation unit 42 to respond to an emergency situation.

Referring to FIG. 5, a tool mark generating apparatus 2 according to an embodiment may connect a computing device 80 and the step motor 31. The computing device 80 may be a variety of devices such as a tablet personal computer (PC), laptop PC, and netbook computer.

For example, the computing device 80 may include a processor 41, a memory 81, a communication unit 82, and an input/output unit 83.

The processor 41 may be included in the control unit 40 in the tool mark generating apparatus 2 according to an embodiment.

For example, the processor 41 may control the speed of the tool 3 operated by the jog wheel of the manual operation unit 42.

The memory 81 may be a hardware component configured to store various pieces of data processed in the tool mark generating apparatus 2, and the memory 81 may store data processed or to be processed by the control unit 41. In the memory 81, data about the operation of the tool mark generating apparatus 2 may be stored.

The communication unit 82 is for the data transfer between the computing device 80 and the step motor 31. The communication unit 82 may include at least one communication module, such as a short-range communication module, a wired communication module, a mobile communication module, and a broadcasting reception module.

The input/output unit 83 may include an input unit and an output unit. In the input/output unit 83, the input unit and the output unit may be separate, or may be integrated into one, such as a touch screen.

The input unit may refer to a component that allows a user to input information for controlling the computing device 80. For example, the input unit may be a key pad, a touch panel, and the like. The output unit may output visual information or sound information. For example, the output unit may include a tool such as a display, lamp, and speaker.

The tool mark generating apparatuses 1 and 2 according to an embodiment may further include a computational unit (not shown). The computational unit may express, either as a formula or in the form of a graph, the relationship between the rotation speed (or rotation acceleration) of the step motor 31 and (i) the types of tools 3 and (ii) the resulting depth (or length) of traces formed on the target object 4.

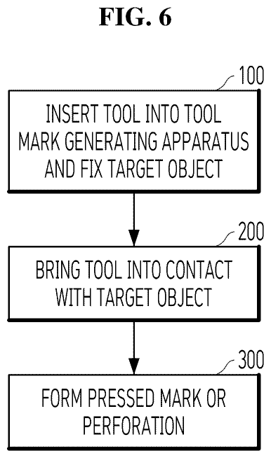

Hereinafter, a method of generating a tool mark using the tool mark generating apparatus 1 according to an embodiment will be described with reference to FIG. 6.

FIG. 6 is a flowchart illustrating a method of generating a tool mark using the tool mark generating apparatus 1 according to an embodiment.

In operation 100, the tool 3 is inserted into the tool mark generating apparatus 1 for 3D digital conversion research, and the target object 4 is fixed.

For example, if the tool 3 is a screwdriver blade, the screwdriver blade may be inserted into the insertion hole 341 of the tool block 34 to be fixed using the adjustment screw 342.

If the target object 4 is a cylindrical butane gas cylinder, it may be positioned to fit into the concave groove 73 of the body 71 of the target object fixing portion 70. The cover 72 may be placed over the upper portion of the butane gas cylinder. If the target object 4 is not directly fixed to the target object fixing portion 70, it may be fixed by being positioned between the first jaw 22 and the second jaw 23 of the vise portion 20, and by adjusting the gap between the jaws. Additionally, depending on the type of the target object 4, a jig (not shown) may be used to fix the object without altering the spacing between the first and second jaws.

In operation 200, the tool 3 is brought into contact with the target object 4.

The step motor 31 is operated to move the tool 3 downward. A wire connects the tool 3 and the target object 4 to measure resistance. When the measured resistance reaches 0 Ω, the operation of the step motor 31 may be stopped, allowing the tool 3 to come into contact with the target object 4. At this time, a zero point of the tool mark generating apparatus 1 may be set, and subsequent operations of the step motor 31 may follow.

In operation 300, the tool 3 is moved downward to form a three-dimensional pressed mark or perforation on the target object 4. The tool 3 may move in a linear direction according to the movement of the nut 33, which is driven by the step motor 31.

In operation 300, a tool mark may be formed by adjusting the insertion depth (length) of the tool 3 while controlling the rotation speed or rotational acceleration of the step motor 31.

Additionally, the above operations may be repeated while changing either the tool 3 or the target object 4.

The computational unit may express the relationship between the rotation speed (or acceleration) of the step motor 31 and the depth (or length) of traces formed by various tools 3 on various target objects 4, either in the form of a mathematical formula or by visualizing it as a graph.

By capturing images of traces (such as pressed marks or perforations) left by various tools 3 on various target objects 4 from multiple angles, three-dimensional traces may be acquired. Based on these 3D traces, research on 3D digital conversion may be conducted.

According to embodiments, the insertion depth of the tool 3 into the target object 4 may be precisely controlled by adjusting the control parameters of the step motor 31, thereby enabling the formation of 3D traces.

Furthermore, various pressed marks and perforations may be formed by using different combinations of tools 3 and target objects 4.

In addition, embodiments may contribute to identifying a suspected tool in violent crimes such as theft and arson, as the typical and cluster characteristics of traces may be analyzed to infer the overall shape of the tool 3 or the target object 4 through a comparative study of the formed traces.

It should be understood that embodiments described herein should be considered in a descriptive sense only and not for purposes of limitation. Descriptions of features or aspects within each embodiment should typically be considered as available for other similar features or aspects in other embodiments. Therefore, the scope of the disclosure is defined by the appended claims.

What is claimed is:

1. A tool mark generating apparatus for 3D digital conversion research, the tool mark generating apparatus comprising:
a base plate;
a vise portion located on the base plate to fix a target object at a position spaced from the base plate; and
an operating portion configured to fix a tool on one side and apply an impact to the target object by moving the tool to form a pressed mark or perforation,
wherein the operating portion comprises: a step motor that rotates at a certain angle in response to a user's input signal; a main screw having a cylindrical shape, configured to convert rotational motion of the step motor into linear motion and to have an external screw thread; a nut comprising an internal screw thread that engages with the screw thread of the main screw and perform linear motion along an axis of the main screw; and a tool block that is coupled to one side of the nut, moves according to movement of the nut, and fixes at least one tool by inserting and securing the tool in a vertically aligned position.

2. The tool mark generating apparatus of claim 1, wherein the vise portion comprises:
a vise body located on the base plate, a first jaw located on one side of the vise body to form a certain height, a second jaw located opposite one side of the first jaw, an adjustment screw having one end inserted and connected to at least one side of the first and second jaws to adjust a gap between the first and second jaws, and a handle screw connected to the other end of the adjustment screw to adjust a rotation direction of the adjustment screw.

3. The tool mark generating apparatus of claim 1, further comprising:
a frame portion configured to fix the step motor and the main screw such that an axial direction of the main screw is oriented vertically.

4. The tool mark generating apparatus of claim 3, further comprising:
a sensor unit disposed on upper and lower portions of the frame portion to configured to detect upper and lower limits of a movement range of the tool.

5. The tool mark generating apparatus of claim 2, further comprising:
a target object fixing portion located on the first and second jaws and having a concave groove formed therein to accommodate the target object.

6. The tool mark generating apparatus of claim 1, further comprising:
a control unit configured to control an operation of the step motor based on user's input information.

7. The tool mark generating apparatus of claim 6, wherein the user's input information comprises:
a rotation speed or a rotation acceleration of the step motor.

8. A method of generating a tool mark for 3D digital conversion research, the method comprising:
inserting a tool into a tool mark generating apparatus for 3D digital conversion research and fixing a target object;
bringing the tool into contact with the target object; and
forming a tool mark by moving the tool downward to form a three-dimensional pressed mark or perforation on the target object.

9. The method of claim 8, wherein the forming of the tool mark comprises:
controlling an insertion depth of the tool by adjusting a rotation speed or a rotation acceleration of a step motor.
